(19) United States
(12) Patent Application Publication
(10) Pub. No.: US 2020/0094968 A1
(43) Pub. Date: Mar. 26, 2020

(54) Socket Insert And Socket For An Aircraft Seat

(71) Applicants: KID-Systeme GmbH, Buxtehude (DE); Airbus Operations GmbH, Hamburg (DE)

(72) Inventors: Walerij Sloboda, Buxtehude (DE); Uwe Beecken, Hamburg (DE); Uwe Donnig, Hamburg (DE)

(73) Assignees: KID-Systeme GmbH, Buxtehude (DE); Airbus Operations GmbH, Hamburg (DE)

(21) Appl. No.: 16/575,918

(22) Filed: Sep. 19, 2019

(30) Foreign Application Priority Data
Sep. 25, 2018 (DE) 10 2018 216 363.4

(51) Int. Cl. B64D 11/06; H01R 13/518; H01R 13/506; G06F 13/40

(52) U.S. Cl. CPC B64D 11/0624; H01R 13/518; G06F 2213/0042; G06F 13/40; H01R 13/506

(57) ABSTRACT

A socket insert includes a lower housing section, which incorporates a current infeed terminal, and an upper housing section, which is connected to the lower housing section, upon one of the sidewalls of which a snap-fit connecting part is arranged. The socket insert further comprises a cover plate, which is integrally connected to the upper housing section, closes the upper housing section to the exterior, and incorporates at least one device terminal which is electrically connected to the current infeed terminal. The cover plate incorporates a peripheral cover plate overhang which projects beyond the side walls of the upper housing section.

### FIELD OF THE INVENTION

The present invention relates to a socket insert, specifically for an electric power supply via a USB charging port, and to a socket, in the socket frame of which a socket insert is accommodated in a form-fitted manner, specifically for integration in an aircraft seat.

### BACKGROUND OF THE INVENTION

The USB serial bus system (USB standing for “Universal Serial Bus”) constitutes an interface between electronic devices, which is primarily intended to permit the rapid and straightforward exchange of data. However, the USB specification also involves the implementation of a charging port (a dedicated charging port, or “DCP”), by means of which USB-enabled electronic devices which incorporate a charge controller and an accumulator can draw electric current for the charging of the accumulator from an electrical energy source which is connected to the charging port. Various USB standards, such as the Battery Charging Specification (USB-BC) or the Power Delivery Specification (USB-PD) govern the maximum permissible currents, charging voltages and arrangements for charging.

The widespread proliferation of personal electronic devices (or “PEDs”) such as smartphones, laptops, E-readers or smart watches also generates a demand for facilities for the recharging of the energy store by passengers of energy storage devices during travel. Many PEDs have dedicated USB interfaces for this purpose, by means of which devices can be connected to corresponding USB charging ports via USB cables.

In passenger aircraft, for example, there is a growing trend for USB charging ports which are integrated into aircraft seats, and which provide passengers with the option for the in-flight charging of their PEDs using the electric power supply of the aircraft passenger cabin. Accordingly, conventional AC sockets are increasingly being replaced by USB charging ports of this type, or at least supplemented by the latter.

### BRIEF SUMMARY OF THE INVENTION

There is consequently a demand for solutions for the simple, rapid and uncomplicated provision of USB charging ports in aircraft, which specifically permit the efficient, time-saving and cost-effective retrofitting of existing aircraft cabins.

According to a first aspect of the invention, a socket insert thus comprises a lower housing section, which incorporates a current infeed terminal, and an upper housing section which is connected to the lower housing section, upon one of the sidewalls of which a snap-fit connecting part is arranged. The socket insert further comprises a cover plate, which is integrally connected to the upper housing section, closes the upper housing section to the exterior, and incorporates at least one device terminal which is electrically connected to the current infeed terminal. The cover plate incorporates a peripheral cover plate overhang which projects beyond the sidewalls of the upper housing section.

According to a second aspect of the invention, a socket comprises a socket frame and a socket insert which is inserted in the socket frame. The upper housing section thus projects through the socket frame. The snap-fit connecting part of the socket insert engages with the reverse side of the socket frame in a form-fitted manner. The cover plate of the socket insert, and the cover plate overhang thereof, moreover lie flush with the front side of the socket frame.

According to a third aspect of the invention, an aircraft seat incorporates a socket integrated in the aircraft seat according to the second aspect of the invention.

A key concept of the invention is the equipment of a socket insert with a two-part housing, in the interior of which electronic components and electrical wiring can be accommodated. At a lower end of the housing, a current infeed cable, for example from an external electrical energy source of an aircraft, can be connected. Electric current is conducted through the housing via corresponding wiring to a cover plate which is fitted to the upper end of the housing, in the surface of which a corresponding device terminal socket is configured for the connection of the electronic device which is to be supplied with electric current.

The cover plate is integrally connected to the housing, and incorporates a degree of overhang in relation to the housing edge. Upon the exact fitting of the housing in a socket frame, the cover plate and the overhang thereof thus come to lie flush with an inner edge of the socket frame. This advantageously permits the covering of a gap between the inner side of the socket frame and the housing of the socket insert, such that the insertion of any tools or objects into the gap, and the penetration of dirt or foreign particles into the gap, are impaired. The thickness of the overhang can be individually adjusted to the requisite installation environment such that, in both height and width, flush fitting of the overhang to said installation environment such as, e.g. a passenger seat, a sidewall or a monument, is achieved.

Flexible connecting parts applied to the sidewalls of the housing form one element of a snap-fit connection, which constitutes a form-fitted connection between the housing and the socket frame further to the insertion of the housing in the socket frame.

According to a number of forms of embodiment of the socket insert, one snap-fit connecting part respectively can be arranged on two opposing sidewalls of the upper housing section. The two snap-fit connecting parts can respectively incorporate two flexible connecting arms having step-shaped graduations. This has the advantage that a secure form-fitted retention of the snap-fit connection between the upper housing section and the socket frame is maintained, even in the event of socket frames of differing thickness. The connecting arms can be comprised, for example, of flexible plastic.

According to a number of forms of embodiment of the socket insert, the step-shaped graduations of the two flexible connecting arms of the respective snap-fit connecting parts can be arranged with a mutual offset along the longitudinal extent of the flexible arms, i.e. the two connecting arms extend in a mutually parallel arrangement away from the cover plate, along the sidewall of the upper housing section to the lower housing section. The step-shaped graduations can be constituted by strips of differing thickness, oriented transversely over the connecting arms. By the offset graduation of the steps in the adjoining connecting arms, depending upon the thickness of the socket frame, one of the two connecting arms respectively can engage with the socket frame, wherein the graduations of one connecting arm are not arranged too close to one another, such that the contact surface of any individual graduation with the inner wall of the socket frame is not excessively reduced.

In order to increase the contact pressure with the inner wall of the socket frame, thereby enhancing the stability of the flexible connecting arms in an advantageous manner, according to a number of further forms of embodiment of the socket insert, metallic spring elements can be respectively arranged between the respective sidewall of the upper housing section and the flexible connecting arms of the respective snap-fit connecting parts, for example in the form of a leaf spring or a helical spring.

According to a number of forms of embodiment of the socket insert, the cover plate can respectively incorporate through holes at the level of the snap-fit connecting parts. As a result, by the insertion of an appropriate tool such as, for example, an Allen key, through the through holes, the respective snap-fit connecting part can be released from engagement with the socket frame, and the socket insert can be removed from the frame.

According to a number of forms of embodiment of the socket insert, the device terminals can comprise USB ports. A socket insert can comprise, for example, one, two or more USB ports on the same cover plate, thereby constituting a USB hub.

### BRIEF DESCRIPTION OF THE DRAWINGS

The invention is described in greater detail hereinafter, in conjunction with and with reference to the exemplary forms of embodiment, as represented in the attached drawings.

The attached drawings are intended to clarify understanding of the present invention, and represent exemplary variants of embodiment of the invention. They illustrate the principles, advantages, technical effects and options for the variation thereof. Naturally, other forms of embodiment incorporating many of the intended advantages of the invention are also conceivable, specifically with reference to the detailed description of the invention provided hereinafter. Components in the drawings are not necessarily represented true to scale and, in the interests of clarity, are partially shown in a simplified or schematic representation. Identical or equivalent components or elements are identified by the same reference numbers.

FIG. 1 shows a perspective view of a socket insert according to one form of embodiment of the invention.

FIG. 2 shows a perspective view of a further socket insert according to another form of embodiment of the invention.

FIG. 3 shows a perspective view of the socket insert according to FIG. 1 during the insertion thereof in a socket frame according to a further form of embodiment of the invention.

FIG. 4 shows a sectional view through a socket insert according to FIG. 1 inserted in a socket frame during the release the snap-fit connection according to a further form of embodiment of the invention.

FIG. 5 shows a perspective underside view of the socket insert according to FIG. 1, according to a further form of embodiment of the invention.

Although specific forms of embodiment are described and represented herein, it will be evident to a person skilled in the art that a wealth of further alternative and/or equivalent implementations of said forms of embodiment can be selected, without essentially departing from the basic concept of the present invention. In general, all variations, modifications and alterations of the exemplary embodiments described herein are also deemed to be encompassed by the present invention.

### DETAILED DESCRIPTION

The directional terminology employed hereinafter, i.e. terms such as “lower”, “upper”, “left”, “right”, “behind”, “in front”, “above”, “below”, etc., is only intended to clarify references to the exemplary illustrations shown in the figures. No limitation of generality is to be implied by these terms.

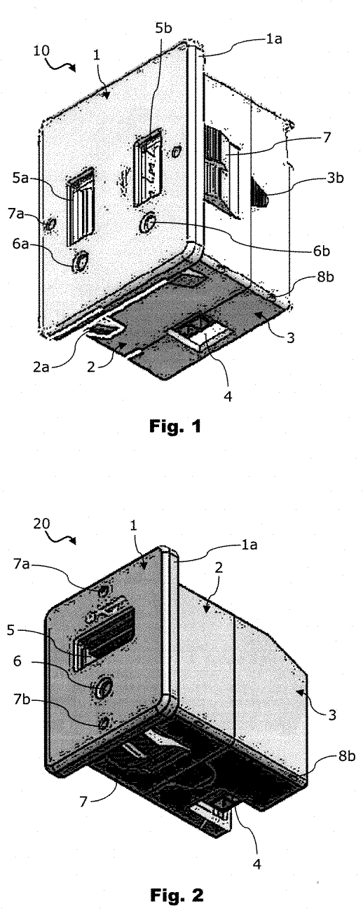

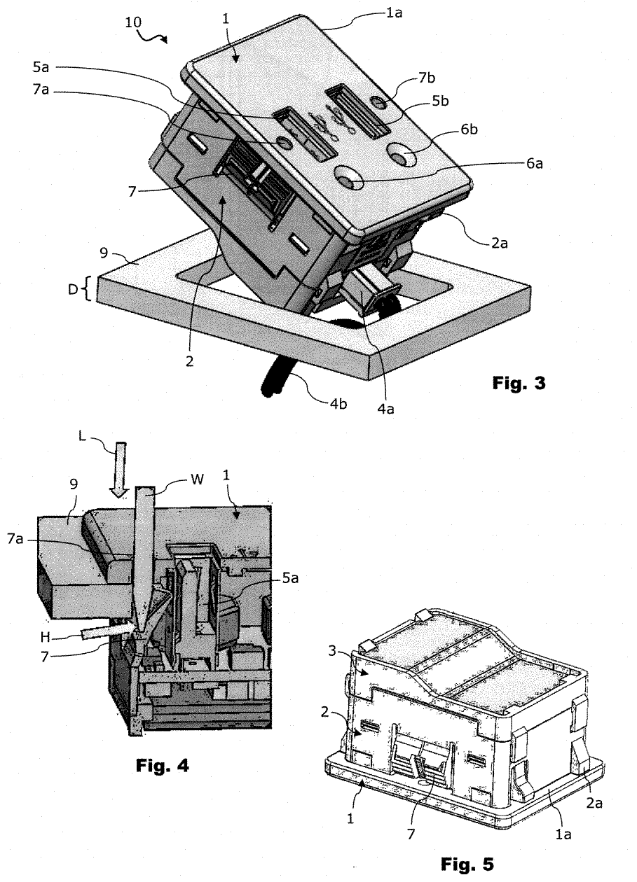

FIG. 1 shows a perspective view of a socket insert 10. FIG. 2 shows a perspective view of a socket insert 20. Essentially, the socket insert 20 only differs from the socket insert 10 according to FIG. 1 with respect to the configuration of the cover plate and the number of terminal sockets for devices which can be connected to the socket insert 20. FIG. 3 represents the socket insert 10 according to FIG. 1 during one stage of the insertion thereof in a socket frame 9. FIG. 4 shows a sectional view through a socket insert 10 according to FIG. 1, which is locked into a socket frame 9. FIG. 4 illustrates a potential method for the release of the form-fitted connection between the socket insert 10 and the socket frame 9. Finally, FIG. 5 shows a perspective underside view of the socket insert 10 according to FIG. 1.

The socket insert 10 comprises a two-part housing having a lower housing section 3 and an upper housing section 2. The housing sections 2 and 3 can be formed, for example, of plastic, and can be appropriately internally structured, such that electronic switching components, electrical conductors or similar components can be accommodated in the interior of the housing. The base of the lower housing section 3 can be covered by a cover plate. In order to simplify the opening and closing of the housing, one surface of the sidewall of the lower housing section 3 can be provided with grip ribs 3b. Moreover, ventilation openings 8b can be provided on the lateral edges of the housing sections 2 or 3, in order to permit the evacuation of exhaust air from the housing or the introduction of cooling air into the housing.

The lower housing section incorporates a current infeed terminal 4, for example in the form of a LAN port, or another appropriate plug connection system. Herein—as represented in FIG. 3—a cable 4b having a corresponding plug 4a can be inserted, in order to permit the establishment of a connection with an electrical energy source or an electrical network. For the application of the socket insert 10 in an aircraft, this can be, for example, the 28V DC on-board network or the 110V DC on-board network.

On one of the sidewalls of the upper housing section 2, a snap-fit connecting part 7 is arranged, for example in the form of one or more flexible connecting arms. It can thus be possible for one snap-fit connecting part 7 respectively to be arranged on two opposing sidewalls of the upper housing section 2. Moreover, one snap-fit connecting part 7 respectively can also be arranged on each of the sidewalls.

As can be seen most clearly in the perspective underside view of the socket insert 10 represented in FIG. 5, the flexible connecting arms can be comprised of plastic, and can incorporate step-shaped graduations. This means that the connecting arms can be bent towards the sidewall of the upper housing section 2, and incorporate strips of different material thickness along the extension from the upper end of the upper housing section 2 to the lower housing section 3, such that shoulders are formed which, depending upon the thickness D of the socket frame 9, engage in a latching arrangement to the rear with the reverse side of the socket frame 9, thus providing a firm seating for the socket insert 10.

In the case of the use of two adjacently arranged flexible connecting arms, the step-shaped graduations can be arranged with a mutual offset along the longitudinal extension of the flexible arms. In other words, the fine graduation of the entire snap-fit connecting part 7 can be doubled, without having to reduce the depth of steps in the individual connecting arms. Depending upon the thickness D of the socket frame 9, either the left-hand connecting arm or the right-hand connecting arm engages in a latching arrangement to the rear with the socket frame 9.

Behind the connecting arms, metallic spring elements such as, for example, helical springs or leaf springs can be arranged between the respective sidewall of the upper housing section 2 and the flexible connecting arms of the respective snap-fit connecting parts 7. In each case, these spring elements are not able to be explicitly represented in the illustrations shown in FIGS. 1, 2, 3 and 5.

The socket insert 10 further comprises a cover plate 1, which is integrally connected with the upper housing section 2. The cover plate 1 thus closes the upper housing section 2 to the exterior, and can function as a cover for the socket insert 10. The cover plate 1 incorporates at least one device terminal which is electrically connected to the current infeed terminal 4 in the interior of the housing. In FIG. 1, two device terminals 5a and 5b are respectively represented as USB ports, while FIG. 2 shows only one device terminal 5 in the form of a USB port. It should be evident that more than two device terminals can also be configured in a cover plate 1, in order to constitute a larger USB hub. Moreover, plug connections other than the USB type can also be selected, for example AUX ports, LAN sockets, jack sockets or similar. LED lights 6a or 6b, which are embedded in the cover plate 1, can function as status indicators for the respective device terminals 5a or 5b.

The cover plate 1 incorporates a peripheral cover plate overhang 1a which projects beyond the sidewalls of the upper housing section 2. At the inner edge of the front side of the socket frame 9, the cover plate 1 thus constitutes a flat seating face, with which the cover plate overhang 1a engages in a flush-fitted manner and generates a counter-pressure to the snap-fit connecting elements 7 which are latched onto the reverse side of the socket frame 9. By the form-fitted accommodation of the housing, with the integrated cover plate 1, in the socket frame 9, the socket insert 10 is seated within the frame 9 in a particularly stable and non-slip manner. In particular, the height or thickness of the integrated cover plate can be individually adapted to the requisite installation environment, such that the desired optical appearance is achieved.

Moreover, at the upper edge of the upper housing section 2, insertion ramps 2a running obliquely away from the underside of the cover plate overhang 1a can be configured on the sidewall of the upper housing section 2. These insertion ramps 2a constitute a mechanical guide for the insertion of the housing in a socket frame, and can offset tolerances in the socket frame opening, thereby preventing any loose movement or slipping of the housing of the socket insert 10 within the socket frame 9.

At the level of the snap-fit connecting parts 7 in each case, through holes 7a or 7b can be configured through the cover plate 1. In the sectional view shown in FIG. 4, it can be seen that an appropriate tool W such as, for example, a pin wrench, an Allen key or another bar-shaped tool, can be guided through the through holes 7a or 7b. The insertion movement L generates a levering action H, which compresses the connecting arms of the snap-fit connecting parts 7 inwards, thereby releasing the engagement thereof with the reverse side of the socket frame 9. As a result, the entire socket insert 10 can be removed from the socket frame 9. By means of the detachable form-fitted connection between the socket insert 10 and the socket frame 9, screw fixings, adhesive bonds or other connecting means can be omitted. At the same time, the form-fitted connection can easily be released, in a non-destructive manner, for maintenance purposes.

By means of the socket with a socket frame 9 and a socket insert 10 or 20 formed according to the connecting procedure represented in FIG. 4, an existing socket frame can be retrofitted with a state-of-the-art socket insert 10 in a simple, efficient and time-saving manner. To this end, a cable 4b is firstly connected to the current infeed terminal 4, and the upper housing section 2 is then inserted in the socket frame 9. The snap-fit connecting parts 7 engage with the reverse side of the socket frame 9 to the rear in a form-fitted manner, while the cover plate 1, with the cover plate overhang 1a, lies flush to the front side of the socket frame 9. Sockets of this type can be integrated, for example, in the aircraft seats of passenger aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A socket insert comprising:
a lower housing section incorporating a current infeed terminal;
an upper housing section connected to the lower housing section and having two opposing sidewalls, wherein a snap-fit connecting part is arranged on at least one of the two opposing sidewall of the upper housing section; and
a cover plate integrally connected to the upper housing section, closing the upper housing section to the exterior, and incorporating at least one device terminal electrically connected to the current infeed terminal,
wherein the cover plate incorporates a peripheral cover plate overhang projecting beyond the two opposing sidewalls of the upper housing section.

2. The socket insert according to claim 1, wherein one snap-fit connecting part respectively is arranged on the two opposing sidewalls of the upper housing section.

3. The socket insert according to claim 2, wherein the two snap-fit connecting parts respectively incorporate two flexible connecting arms having step-shaped graduations.

4. The socket insert according to claim 3, wherein the step-shaped graduations of the two flexible connecting arms of the respective snap-fit connecting parts are arranged with a mutual offset along the longitudinal extent of the flexible arms.

5. The socket insert according to claim 3, wherein a metallic spring element is respectively arranged between the respective sidewall of the upper housing section and the flexible connecting arms of the respective snap-fit connecting parts.

6. The socket insert according to claim 5, wherein the metallic spring elements comprise helical springs or leaf springs.

7. The socket insert according to claim 2, wherein the cover plate respectively incorporates through holes at the level of the snap-fit connecting parts.

8. The socket insert according to claim 1, wherein the at least one device terminal comprises a USB port.

9. A socket comprising:
a socket frame having a front side and a reverse side; and
a socket insert according to claim 1, wherein the upper housing section of the socket insert is inserted in the socket frame, the snap-fit connecting part of the socket insert engages to the rear with the reverse side of the socket frame in a form-fitted manner, and the cover plate of the socket insert, and the cover plate overhang thereof, lie flush with the front side of the socket frame.

10. An aircraft seat having an integrated socket according to claim 9.
